(19) United States
(12) Patent Application Publication
(10) Pub. No.: US 2012/0195035 A1
(43) Pub. Date: Aug. 2, 2012

(54) AMBULITE SYSTEMS

(76) Inventors: Lucinda Rodriguez, Metairie, LA (US); Ralph J. Rodriguez, Metairie, LA (US)

(21) Appl. No.: 13/361,116

(22) Filed: Jan. 30, 2012

Related U.S. Application Data
(60) Provisional application No. 61/437,823, filed on Jan. 31, 2011.

(51) Int. Cl. F21L 4/00

(52) U.S. Cl. 362/190

(57) ABSTRACT

An emergency alerting system comprising: a lighting assembly; at least one attacher; and a portable frame with legs, the legs able to be telescoped in relation to the portable frame. The lighting assembly including: a housing; a base plate; a lamp; a powerer with a wiring assembly; and an on/off switch. The housing is coupled to the base plate to enclose the lamp therewithin to protect the lamp from impact and environmental damage. The emergency alerting system is useful in visually directing emergency responders to the scene of an accident. The powerer powers the lamp of the lighting assembly via the wiring assembly, the powerer activating/de-activating the lighting assembly via the on/off switch; the lamp in electrical communication with the powerer via the wiring assembly. The lighting assembly is portable and the lamp comprises a stroboscopic lamp to produce colored regular flashes of light.

### CROSS-REFERENCE TO RELATED APPLICATION

The present application is related to and claims priority from prior provisional application Ser. No. 61/437,823, filed Jan. 31, 2011 which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

1. Field of the Invention

The present invention relates generally to the field of lights and alerting means and more specifically relates to an ambulite emergency alerting system.

2. Description of the Related Art

An ambulance is a vehicle for transporting sick or injured individual(s) to, from or between places for treatment for an illness or injury, and in some instances will also provide out of hospital medical care to the patient. These vehicles are not usually (although there are exceptions) equipped with life-support equipment, and are usually crewed by staff of emergency personnel. Their purpose is simply to transport patients to, from or between places of treatment. However, it may prove difficult for emergency response vehicles to locate accidents, whether responding to a car accident, an accident in the home, or an accident elsewhere. Further, if it's dark outside, emergency responders may not be able see as sharply as they could in natural light and may potentially make a wrong turn if they are in a residential area or could drive past the location of the accident. Also, it can be difficult for responders to read house numbers, and not all houses have readily displayed numbers. Additionally, in the case of fires and emergency health care, the amount of time before assistance arrives can be crucial to survival rates.

Strobe lights are used in scientific and industrial applications, in night clubs where they are used to give an illusion of slow motion, and for aircraft anti-collision lighting. Other applications are in alarm systems, theatrical lighting (most notably to simulate lightning), and as high-visibility running lights. It is desirable that an emergency location be clearly indicated such that emergency personnel may respond with maximum efficiency.

Various attempts have been made to solve the above-mentioned problems such as those found in U.S. Pat. and Pub. Nos. 2007/0241922; 7,298,245; 6,000,811; 4,547,761; 5,991,363; and 4,855,723. This prior art is representative of emergency alert systems. None of the above inventions and patents, taken either singly or in combination, is seen to describe the invention as claimed.

Ideally, an emergency beacon should be effective in indicating an emergency location, be portable and, yet, would operate reliably and be manufactured at a modest expense. Thus, a need exists for a reliable ambulite system that can assist emergency vehicles, such as an ambulance, a fire truck, or a police car, in efficiently responding to where they are needed and to avoid the above-mentioned problems.

### BRIEF SUMMARY OF THE INVENTION

In view of the foregoing disadvantages inherent in the known lights and alerting means art, the present invention provides a novel Ambulite system. The general purpose of the present invention, which will be described subsequently in greater detail is to provide ambulite emergency alerting system that can efficiently assist emergency vehicles, such as an ambulance, a fire truck, or a police car, in efficiently responding to where they are needed.

Ambulite comprises a recognizable and bright strobe light that can assist emergency vehicles, such as an ambulance, a fire truck, or a police car, in efficiently responding to where they are needed. This device can save valuable time and, potentially, a life by clearly directing emergency responders to the scene of an accident. The product can be battery operated. An adhesive pad is preferably placed on the underside of the specially designed strobe light. The light can then be adhered to a mailbox or a front door. Alternatively, in other embodiments the light can also be adhered to the top of a tripod and then placed in the yard, down a road, or virtually anywhere needed to guide emergency responders. Once the light has been placed in an optimal location, it can be turned on and the strobe light can begin to blink.

An emergency alerting system is disclosed herein, in a preferred embodiment comprising: a lighting assembly; at least one attacher; and a portable frame with legs, the legs able to be telescoped in relation to the portable frame. The lighting assembly including: a housing; a base plate; a lamp; a powerer with a wiring assembly; and an on/off switch. The housing is able to be coupled to the base plate to enclose the lamp therewithin to protect the lamp from impact and environmental damage.

The emergency alerting system is useful in visually directing emergency responders to the scene of an accident. The portable frame with legs is designed to elevate the lighting assembly and comprises a tripod with a center-leg. The lighting assembly is about 6 inches in diameter and about 2½ inches in height in preferred embodiments. The powerer powers the lamp of the lighting assembly via the wiring assembly, the powerer activating/de-activating the lighting assembly via the on/off switch, the lamp in electrical communication with the powerer via the wiring assembly. The lighting assembly is removably couplable to a horizontal surface via the attacher. The lighting assembly is portable and the lamp preferably comprises a stroboscopic lamp to produce regular flashes of light. The stroboscopic lamp comprises a flash energy in the region (range) of about 10 to about 150 joules in preferred embodiments. Further, the stroboscopic lamp provides regular flashes of colored light.

The emergency alerting system further comprises a kit including the lighting assembly; the attacher(s) comprising peelable adhesive pads; the powerer comprising batteries; the portable frame with legs; a leg-strap; and a remote activating device.

A method of using an emergency alerting system is also described herein comprising the steps of: removably coupling a lighting assembly to a planar surface; activating a lamp in the lighting assembly to indicate an emergency situation in a particular location; summoning emergency personnel to that particular location to alleviate the emergency situation; and activating in certain embodiments is able to be accomplished via a remote control (remote activating device).

The present invention holds significant improvements and serves as an ambulite system. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, ambulite system, constructed and operative according to the teachings of the present invention.

FIG. 1 shows a perspective view illustrating an emergency alerting system in an ‘in-use’ position according to an embodiment of the present invention.

FIG. 2 is a perspective view illustrating the emergency alerting system removably-attached to a tripod according to an embodiment of the present invention.

FIG. 3 is a perspective view illustrating attacher(s) removeably-attaching to the tripod and a stroboscopic lamp of emergency alerting system according to an embodiment of the present invention.

FIG. 4 is a perspective view illustrating the emergency alerting system removably-attached a mailbox in front of a house according to an embodiment of the present invention.

FIG. 5 is a flowchart illustrating a method of use according to an embodiment of the present invention of FIGS. 1-4.

The various embodiments of the present invention will hereinafter be described in conjunction with the appended drawings, wherein like designations denote like elements.

### DETAILED DESCRIPTION

As discussed above, embodiments of the present invention relate to a lights and alerting means device and more particularly to an ambulite system that can assist emergency vehicles, such as an ambulance, a fire truck, or a police car, in efficiently responding to where they are needed.

Generally speaking, Ambulite of the present invention alerts emergency response vehicles to the location of an accident by the flashing of a strobe light. This unique product may comprise an amber, red, or blue strobe light, measuring approximately 6″ in diameter and 2½″ in height. The device can have a clear plastic covering, an attachment plate on the bottom, and an on/off switch on the side. The light can be battery operated. The strobe light can come with adhesive pads, a hook on the outer portion of the plate from which it can hang, and a tripod. The adhesive pads can stick to the attachment plate on the bottom and then adhere to the wall or substantially any other surface.

The tripod can be made of plastic and may have 3 (or more) legs, with a leg in the center for balance. There can be hinges at all the joints, for easy collapsing and storage. There can be a strap attached to one of the legs, such that when the tripod is closed, it can wrap around and fasten via hook and loop fasteners. The device can also be permanently mounted to a house and linked up with the house's electrical wiring, so that it can be turned on by a switch inside the house or a remote activating device that a person can carry with them. It should be appreciated that strobe lighting can trigger seizures in photosensitive epilepsy, thus alerting means other than ‘strobing’ may be used or strobe lights may be limited to not exceed 5 flashes per second (at which only about 5% of photosensitive epileptics may be at risk).

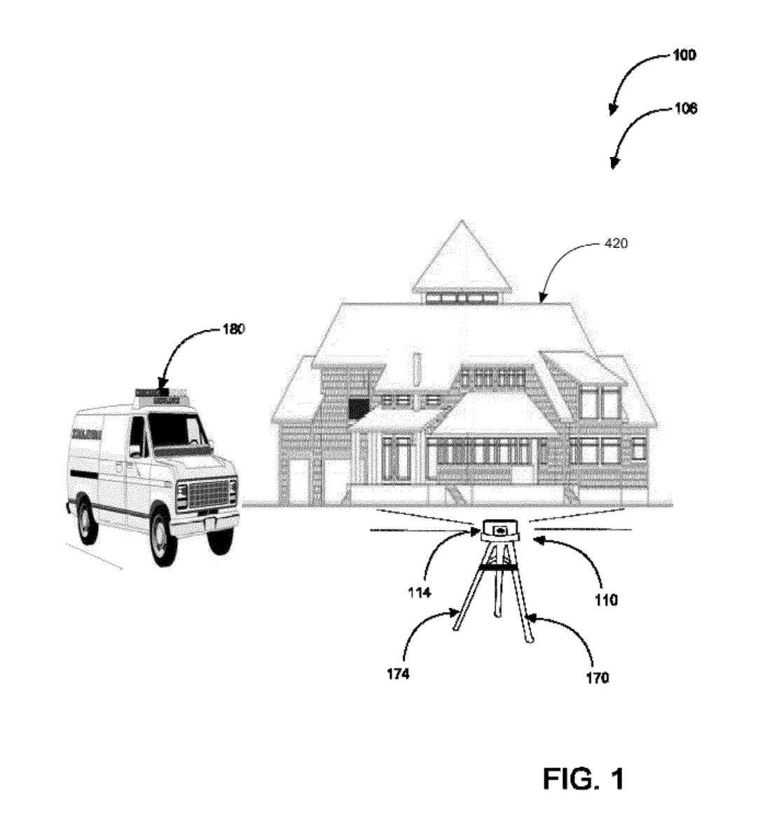

Referring to the drawings by numerals of reference there is shown in FIG. 1, a perspective view illustrating emergency alerting system 100 in ‘in-use’ position 106 according to an embodiment of the present invention.

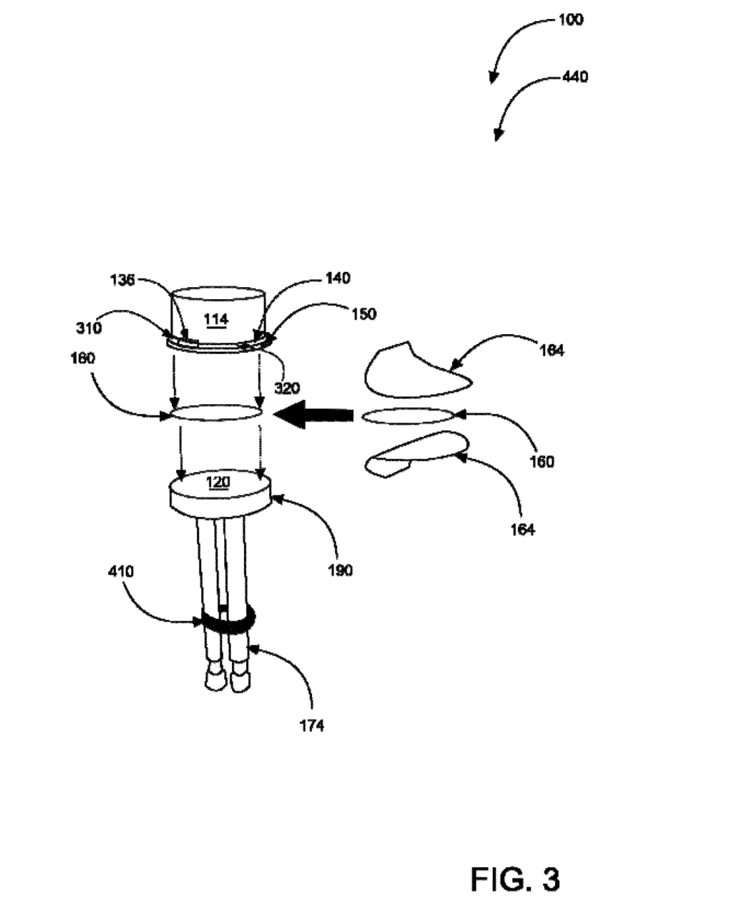

Emergency alerting system 100 preferably comprises: lighting assembly 110 and attacher 160. Lighting assembly 110 includes housing 114; base plate 120; lamp 128; powerer 136 with wiring assembly 140; and on/off switch 150. Emergency alerting system 100 is useful in visually directing emergency responders 180 to the scene of an accident. Lighting assembly 110 is removably couplable to horizontal surface 190 via attacher 160. Attacher 160 preferably comprises peelable adhesive pads 164 as shown best in FIG. 3.

Housing 114 is coupled to base plate 120 to enclose lamp 128 therewithin to protect lamp 128 from impact and environmental damage. Powerer 136 powers lamp 128 of lighting assembly 110 via wiring assembly 140, powered 136 activating/de-activating lighting assembly 110 via on/off switch 150; lamp 128 is in electrical communication with powerer 136 via wiring assembly 140.

Emergency alerting system 100 further comprises portable frame with legs 170, in preferred embodiments, designed to elevate lighting assembly 110. Portable frame with legs 170 comprises tripod 174 with center-leg 176. Lighting assembly 110 is about 6 inches in diameter and about 2½ inches in height. As such the present invention is readily portable and storable.

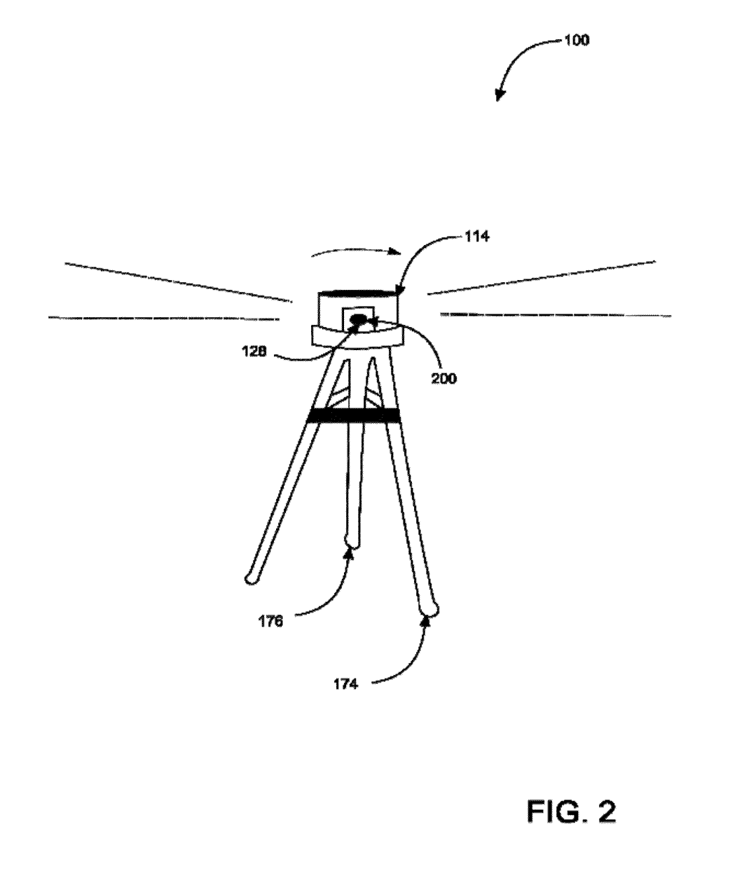

Referring now to FIG. 2, a perspective view illustrating emergency alerting system 100 removably-attached to tripod 174 according to an embodiment of the present invention.

Lighting assembly 110 is portable and lamp 128 comprises stroboscopic lamp 200 to produce regular flashes of light. Stroboscopic lamp 200 comprises a flash energy in the region of 10 to 150 joules in preferred embodiments to minimize potential for causing epileptic attacks in susceptible individuals. Stroboscopic lamp 200 provides regular colored flashes of light. The colored gels are used to provide colored regular flashes of light. The regular flashes of light comprise red or may comprise other colors as referenced herein. Upon reading this specification, it should be appreciated that, under appropriate circumstances, considering such issues as user preferences, design preference, structural requirements, marketing preferences, cost, available materials, technological advances, etc., other regular flashes of light arrangements such as, for example, amber, blue, green, yellow, etc., may be sufficient.

Stroboscopic lamp 200 as used herein may comprise a capacitor, an energy storage device much like a battery, but capable of charging and releasing energy much faster. In certain embodiments strobe light may use rectified mains electricity and no capacitors at all. In this particular invention a capacitor based strobe light is preferably used, the capacitor is charged up to around 300V. Once the capacitor has been charged, a small amount of power is diverted into a trigger transformer with a high turns ratio, which generates a weak, but high voltage spike required to ionize xenon gas (contained) in a flash tube. An arc is created inside the tube, which acts as a bridge for the much bigger pulse to flow down later. Arcs present almost a direct short circuit, allowing the capacitors to quickly release their energy into the arc. This rapidly heats the xenon gas, creating an extremely bright plasma discharge, which is seen as ‘the flash’.

In embodiments without a capacitor storage device the device simply discharges mains voltages across the tube once it's fired. This method means no charging times are required, and flash rates can be much faster, but drastically reduce the lifetime of the flash tube if powered for excess amounts of time, making it less preferred because of its decreased longevity. These strobes require a form of current limiting, as mentioned previously, the arc acting as a short circuit. If this current limiting was eliminated, the flash tube would attempt to draw high currents from the electricity source which is undesirable.

A strobe flash typically lasts around 200 microseconds, however can be faster or slower depending on the user preference when using the present invention. Certain embodiments may allow for adjustment of the strobe flash. Continuous mode, where the arc is sustained, provides an extremely high intensity light, but usually only for small amounts of time to prevent overheating of the flash tube and thus breakage may be used in certain embodiments.

Referring now to FIG. 3, illustrating attacher(s) 160 removeably-attaching to tripod 174 and stroboscopic lamp 200 of emergency alerting system 100 according to an embodiment of the present invention.

Lighting assembly 110 further comprises a trigger transformer 310 with a high turns ratio, which generates a weak, but high voltage spike required to ionize xenon gas in a flash tube. Lighting assembly 110 further comprises current limiter 320. Current limiter 320 acts as a means of imposing an upper limit on the current that may be delivered to a load with the purpose of protecting the circuit generating or transmitting the current from harmful effects due to a short-circuit or similar problem in the load.

Lamp 128 comprises at least one LED 330 in certain embodiments. LED 330 preferably comprises a wavelength of 610<λ<760 nm comprising a red light. LED 330 may use Aluminium gallium arsenide (AlGaAs); Gallium arsenide phosphide (GaAsP); Aluminium gallium indium phosphide (AlGaInP); or Gallium (III) phosphide (GaP) as semiconductor material. Voltage drop in red LED 330 may be about 0.63<ΔV<2.03. Wavelength may be about 610<λ760 nm. Other colors for LED 330 may also be used as previously mentioned; however red is preferred because of its close affiliation to emergency situations to the public at large.

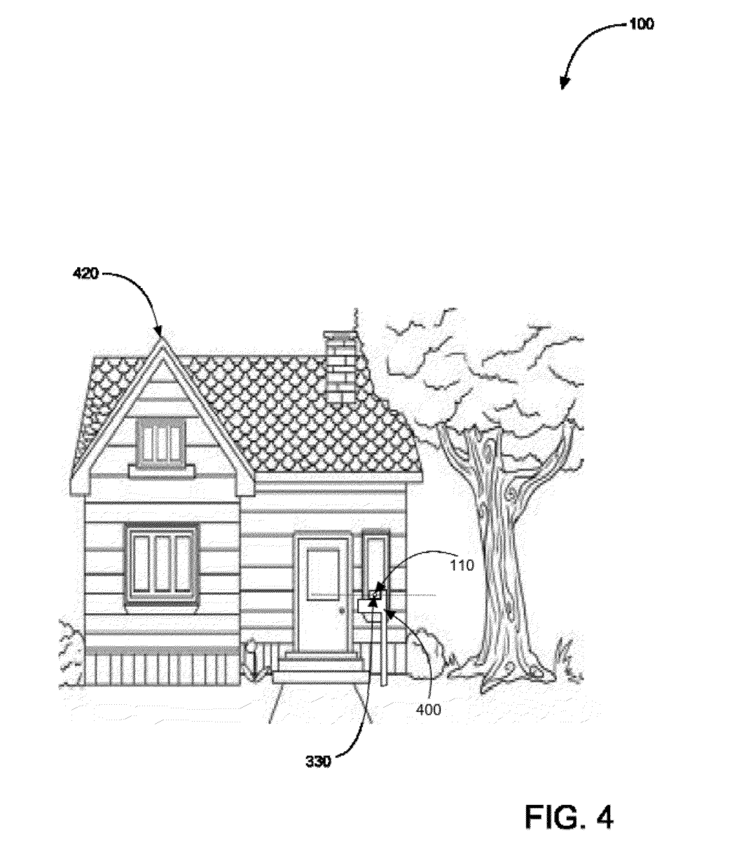

FIG. 4 illustrates emergency alerting system 100 removably-attached to mailbox 400 in front of house 420 according to an embodiment of the present invention.

Emergency alerting system 100 may be sold as kit 440 comprising the following parts: lighting assembly 110; attacher(s) 160 comprising peelable adhesive pads 164; powered 136 comprising batteries; portable frame with legs 170; leg-strap 410; a remote activating device; and at least one set of user instructions. Emergency alerting system 100 may be manufactured and provided for sale in a wide variety of sizes and shapes for a wide assortment of applications. Upon reading this specification, it should be appreciated that, under appropriate circumstances, considering such issues as design preference, user preferences, marketing preferences, cost, structural requirements, available materials, technological advances, etc., other kit contents or arrangements such as, for example, including more or less components, customized parts, different color combinations, parts may be sold separately, etc., may be sufficient.

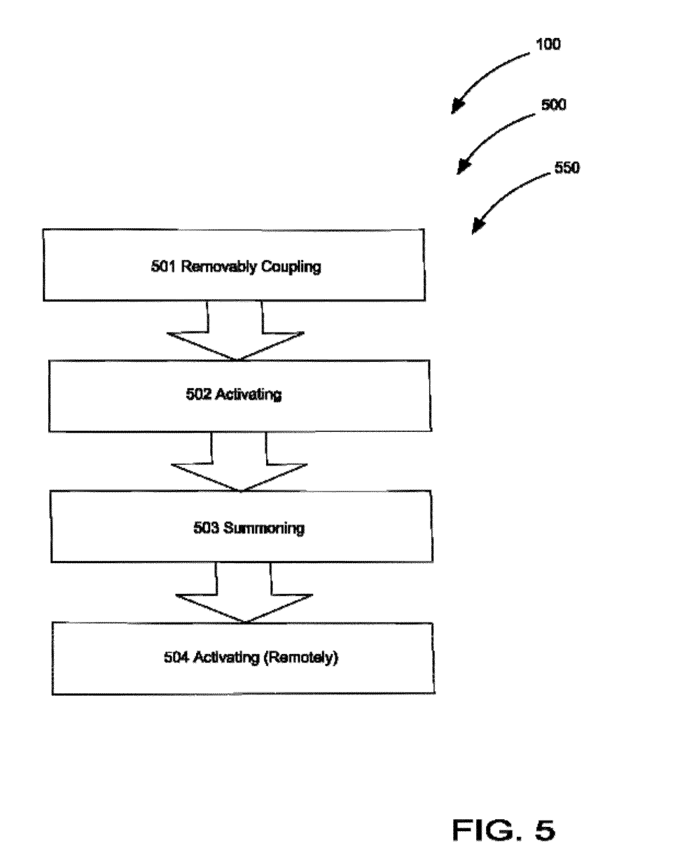

Referring now to FIG. 5, a flowchart 550 illustrating a method of using emergency alerting system 500 according to an embodiment of the present invention of FIGS. 1-4.

A method of using (enabling method of use 500) emergency alerting system 100 preferably comprises the steps of: step one 501 removably coupling lighting assembly 110 to a planar surface; step two 502 activating lamp 128 in lighting assembly 110 to indicate an emergency situation in a particular location; step three 503 summoning emergency personnel to the particular location to alleviate emergency situation; and step four 504 (optional) activating is able to be accomplished via a remote control (means).

It should be noted that step 504 is an optional step and may not be implemented in all cases. Optional steps of method 500 are illustrated using dotted lines in FIG. 5 so as to distinguish them from the other steps of method 500.

It should be noted that the steps described in the method of use can be carried out in many different orders according to user preference. The use of “step of” should not be interpreted as “step for”, in the claims herein and is not intended to invoke the provisions of 35 U.S.C. §112, ¶6. Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. An emergency alerting system comprising:
a lighting assembly including;
a housing;
a base plate;
a lamp;
a powerer with a wiring assembly;
an on/off switch; and
an attacher;
wherein said housing is coupled to said base plate to enclose said lamp therewithin to protect said lamp from impact and environmental damage;
wherein said powerer powers said lamp of said lighting assembly via said wiring assembly, said powerer activating/de-activating said lighting assembly via said on/off switch, said lamp in electrical communication with said powerer via said wiring assembly;
wherein said lighting assembly is removably couplable to a horizontal surface via said attacher; and
wherein said emergency alerting system is useful in visually directing emergency responders to the scene of an accident.

2. The emergency alerting system of claim 1 wherein said lighting assembly is portable and said lamp comprises a stroboscopic lamp to produce regular flashes of light.

3. The emergency alerting system of claim 2 wherein said stroboscopic lamp comprises a flash energy in the region of 10 to 150 joules.

4. The emergency alerting system of claim 2 wherein said stroboscopic lamp provides a colored said regular flashes of light.

5. The emergency alerting system of claim 4 wherein colored gels are used to provide said colored said regular flashes of light.

6. The emergency alerting system of claim 5 wherein said regular flashes of light comprises red.

7. The emergency alerting system of claim 5 wherein said regular flashes of light comprises amber.

8. The emergency alerting system of claim 5 wherein said regular flashes of light comprises blue.

9. The emergency alerting system of claim 1 wherein said lighting assembly further comprises a capacitor.

10. The emergency alerting system of claim 1 wherein said lighting assembly further comprises a trigger transformer with a high turns ratio, which generates a weak, but high voltage spike required to ionize xenon gas in a flash tube.

11. The emergency alerting system of claim 1 wherein said lighting assembly further comprises a current limiter.

12. The emergency alerting system of claim 1 wherein said lamp comprises at least one LED.

13. The emergency alerting system of claim 12 wherein said LED comprises a wavelength of 610<λ<760 nm comprising a red said light.

14. The emergency alerting system of claim 1 further comprising a portable frame with legs designed to elevate said lighting assembly.

15. The emergency alerting system of claim 1 wherein said portable frame with legs comprises a tripod with a center-leg.

16. The emergency alerting system of claim 1 wherein said lighting assembly is about 6 inches in diameter and about 2½ inches in height.

17. An emergency alerting system comprising:
a lighting assembly including;
a housing;
a base plate;
a lamp;
a powerer with a wiring assembly;
an on/off switch;
at least one attacher; and
a portable frame with legs, said legs able to be telescoped in relation to said portable frame;
wherein said housing is coupled to said base plate to enclose said lamp therewithin to protect said lamp from impact and environmental damage;
wherein said lighting assembly is about 6 inches in diameter and about 2½ inches in height;
wherein said powerer powers said lamp of said lighting assembly via said wiring assembly, said powerer activating/de-activating said lighting assembly via said on/off switch, said lamp in electrical communication with said powerer via said wiring assembly;
wherein said lighting assembly is removably couplable to a horizontal surface via said attacher;
wherein said lighting assembly is portable and said lamp comprises a stroboscopic lamp to produce regular flashes of light;
wherein said stroboscopic lamp comprises a flash energy in the region of about 10 to about 150 joules;
wherein said stroboscopic lamp provides a colored said regular flashes of light;
wherein said portable frame with legs is designed to elevate said lighting assembly;
wherein said portable frame with legs comprises a tripod with a center-leg; and
wherein said emergency alerting system is useful in visually directing emergency responders to the scene of an accident.

18. The emergency alerting system of claim 17 wherein said emergency alerting system further comprises a kit including said lighting assembly; said attacher(s) comprising said peelable adhesive pads; said powerer comprising batteries; said portable frame with legs; a leg-strap; and a remote activating device.

19. A method of using an emergency alerting system comprising the steps of:
removably coupling a lighting assembly to a planar surface;
activating a lamp in said lighting assembly to indicate an emergency situation in a particular location; and
summoning emergency personnel to said particular location to alleviate said emergency situation.

20. The method of claim 19 wherein said activating is able to be accomplished via a remote control.
